(19) United States
(12) Patent Application Publication
(10) Pub. No.: US 2025/0339924 A1
(43) Pub. Date: Nov. 6, 2025

(54) JET NOZZLE WITH OPPOSING INJECTOR GUIDES

(71) Applicant: TRUMPF Laser- und Systemtechnik SE, Ditzingen (DE)

(72) Inventors: Tim Hesse, Ditzingen (DE); Jakob Spiecker, Stuttgart (DE); Niels Schäfer, Stuttgart (DE); Julius Irrek, Ditzingen (DE); Alessandro Käfer, Gerlingen (DE); Andreas Scholz, Taunusstein (DE); Timo Steeb, Leonberg (DE); Ralf Eckardt, Rutesheim (DE); Björn Sautter, Leonberg (DE)

(21) Appl. No.: 19/273,156

(22) Filed: Jul. 18, 2025

Related U.S. Application Data
(63) Continuation of application No. PCT/EP2024/051300, filed on Jan. 19, 2024.

(30) Foreign Application Priority Data
Jan. 27, 2023 (DE) 10 2023 102 043.9
Oct. 10, 2023 (DE) 10 2023 127 619.0

(51) Int. Cl. B23K 26/34; B23K 26/14; B33Y 80/00

(52) U.S. Cl. CPC B23K 26/34; B23K 26/1462; B33Y 80/00

(57) ABSTRACT

A jet nozzle is for laser cladding along a direction of advance. The jet nozzle includes a light channel for conducting at least one laser beam directed onto a workpiece; and a powder unit arranged radially outside the light channel for conducting at least one jet of powder which is to be applied to the workpiece with at least a first powder focus. The powder unit forms a powder section at a mouth of the jet nozzle in a circumferential direction around the light channel. The powder section includes a plurality of injector guides, into each of which a powder injector is configured to be inserted. A first injector guide is located substantially opposite a second injector guide in relation to the first powder focus.

### CROSS REFERENCE TO RELATED APPLICATIONS

This application is a continuation of International Application No. PCT/EP2024/051300 (WO 2024/156619 A1), filed on Jan. 19, 2024, and claims benefit to German Patent Application No. DE 10 2023 127 619.0, filed on Oct. 10, 2023 and to German Patent Application No. DE 10 2023 102 043.9 filed on Jan. 27, 2023. The aforementioned applications are hereby incorporated by reference herein.

### FIELD

The present invention relates to a jet nozzle for laser cladding along a direction of advance and a method for laser cladding.

### BACKGROUND

Laser cladding is used in the fields of repair, coating, and/or joining technology, for example. A distinction can be made between conventional laser cladding techniques (laser metal deposition (LMD), direct metal deposition (DMD) or direct energy deposition (DED)), and high-speed laser cladding (high-speed laser metal deposition (HS-LMD) or extreme high-speed laser application (EHLA)). HS-LMD methods are described, for example, in the disclosure documents DE 10 2011 100 456 A and DE 10 2018 130 798 A1. Another method for laser cladding is known from the Chinese patent application CN 109175372 A.

A functional layer can be applied to a workpiece by means of laser cladding. This generally increases the load-bearing capacity of the workpiece processed by means of laser cladding compared to an unprocessed workpiece. The functional layer can serve as a wear protection layer, for example. The application of the functional layer is based on a melting of a workpiece surface, an application of a powdered filler material, and a subsequent cooling so that a matrix structure with hard material particles is materially bonded to the material surface. Laser cladding therefore engages with the inner material structure of the workpiece and changes it. Under certain circumstances, this can result in imperfections in the internal material structure. These can impair the desired increase in resilience. The imperfections can be of a microscopic nature, which is why they can only be identified with great effort.

### SUMMARY

In an embodiment, the present disclosure provides a jet nozzle for laser cladding along a direction of advance, including a light channel for conducting at least one laser beam directed onto a workpiece; and a powder unit arranged radially outside the light channel for conducting at least one jet of powder which is to be applied to the workpiece with at least a first powder focus. The powder unit forms a powder section at a mouth of the jet nozzle in a circumferential direction around the light channel. The powder section includes a plurality of injector guides, into each of which a powder injector is configured to be inserted. A first injector guide is located substantially opposite a second injector guide in relation to the first powder focus.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a jet nozzle during laser cladding;

FIG. 2 shows a side view of a jet nozzle;

FIG. 3 shows a perspective view of the jet nozzle from FIG. 2;

FIG. 4 shows the jet nozzle from FIG. 2 connected to other components;

FIG. 5 shows a top view of a distal region of the jet nozzle from FIG. 2;

FIG. 6 shows a top view of a flange section of the jet nozzle from FIG. 2;

FIG. 7 shows another perspective view of the jet nozzle from FIG. 2;

FIG. 8 shows a perspective sectional view of the jet nozzle from FIG. 2;

FIG. 9 shows the jet nozzle in a further embodiment in a top view of a distal region;

FIG. 10 shows the jet nozzle with a process gas unit in a top view of the distal region;

FIG. 11 shows another perspective sectional view of the jet nozzle with an angled end face;

FIG. 12 shows a further embodiment of the jet nozzle with a geometrically adapted mouth of the nozzle in a side view;

FIG. 13 shows a further embodiment of the jet nozzle with a first powder section and a second powder section;

FIG. 14 shows a plan view of the embodiment shown in FIG. 13;

FIG. 15 shows a further embodiment of the jet nozzle with a first powder section and a second powder section;

FIG. 16 shows a plan view of the embodiment shown in FIG. 15; and

FIG. 17 shows a jet nozzle with a chamfer, which is moved up to a hub cap of a brake disk.

### DETAILED DESCRIPTION

Embodiments of the present invention provide an improved jet nozzle as well as an improved method for laser cladding along a direction of advance. Particular embodiments aim to increase the welding quality of a deposited functional layer and of the workpiece as a whole, and to reduce or avoid imperfections in a welded joint between a powdered filler material and a material surface. For example, the jet nozzle can aim to enable reliable application of the functional coating in the region of a hub cup of a rotationally symmetrical component, such as a brake disk, especially with a lateral incidence angle of greater than 5° between the jet nozzle and the component. The lateral incidence angle describes the inclination of the jet nozzle in relation to a workpiece about an advance axis along which the direction of advance runs. The imperfections to be avoided can be a wavy functional layer that deviates from the desired smooth functional layer and can result, in particular embodiments, from an improperly applied filler material on the component surface. The imperfections can also be bonding defects between the material surface and the applied functional layer or between individual applied functional layers. The imperfections can also be pores, i.e., air pockets, which occur within the applied functional layer, or between the applied functional layer and the material surface. In particular embodiments, if the material surface is a cast material, pores can occur more frequently. The imperfections can also be cracks that run vertically to the material surface within the applied functional layer. The imperfections can also result from the fact that powder particles, in particular embodiments carbides, of the powdered filler material dissolve in a matrix material of the powdered filler material, which leads to the matrix material becoming brittle. Particular embodiments also aim to provide a reliable jet nozzle that is resistant to thermal stresses. Embodiments can also aim to design the jet nozzle in such a way that it ensures reliable and precise laser cladding over a very high number of cycles.

Accordingly, a jet nozzle for laser cladding along a direction of advance is proposed, which has a light channel for conducting at least one laser beam directed onto a workpiece. Laser cladding can be a method for high-speed laser metal deposition (HS-LMD). The direction of advance is the direction along which the jet nozzle moves relative to the workpiece. It can result from a movement, in particular embodiments a rotational movement, of the workpiece, from a movement of the jet nozzle, or from a superposition of both movements. The direction of advance and the correlating advancement movement can be constant over the course of the process. Alternatively, they can vary with the respective process stage. The workpiece can be a rotationally symmetrical workpiece, such as a brake disk, a hydraulic cylinder, a pressure roller, or a plain bearing. The laser beam can shine through the light channel. It can be provided by a laser source, from which the laser beam is guided by means of an optical fiber cable to a laser system that splits the laser beam via a collimating lens and focuses it in line with the process via laser optics before it enters the jet nozzle. The light channel can be a hollow channel that runs through the entire jet nozzle along a longitudinal direction. In addition to the laser beam, a process gas can also be directed to the workpiece surface through the light channel.

The jet nozzle also has a powder unit arranged radially outside the light channel for conducting at least one jet of powder, which is to be applied to the workpiece with at least a first powder focus. Starting from the longitudinal direction of the jet nozzle, the powder unit can be radially outside the light channel and can be part of an outer structure that surrounds the light channel in a closed manner. The jet of powder can carry at least one powdered filler material consisting of hard material particles, in particular carbides, and a matrix material. The powder unit can be the part of the jet nozzle that is provided to conduct the powdered filler material directly or indirectly. The jet of powder is completely or partially focused on the first powder focus. The first powder focus is the point at which the powder unit directs the jet of powder. The first powder focus can be eccentric to a center of the light channel.

At a mouth of the nozzle, the powder unit forms a powder section in a circumferential direction around the light channel, which has a plurality of injector guides, into each of which, in particular embodiments, a powder injector can be inserted, wherein a first injector guide is located essentially opposite a second injector guide in relation to the first powder focus. An injector guide can serve as a holder for a powder injector. Alternatively, the injector guides themselves represent injector openings through which the powder material is fed through the jet nozzle without needing to rely on additional powder injectors. The powder unit can be part of the mouth of the nozzle. The mouth of the nozzle is the part of the jet nozzle facing the workpiece. The end section of the mouth of the nozzle has a distal region. This is the part of the mouth of the nozzle that is closest to the workpiece. On the section facing away from the workpiece, the jet nozzle has a proximal region and a flange section. The proximal region and the flange section are the part of the jet nozzle facing away from the workpiece. The nozzle can be coupled to another component of the laser system, such as laser optics or a process unit, via the flange section. The powder section can form a section of the circumference of the mouth of the nozzle around the light channel. For example, the powder section can make up the greater part of the circumference of the mouth of the nozzle. The injector guides can be cylindrical or conical through-openings in the region of the mouth of the nozzle, into each of which a powder injector can be inserted. The injector guides can be inserted into the mouth of the nozzle by means of machine-cutting. In preferred embodiments, however, they are already provided during an additive manufacturing of the jet nozzle. The injector guides can be adapted to the powder injector to be used. The first injector guide can be point-mirrored to the second injector guide at the first powder focus. It can also be point-mirrored by a deviation of 5° to 15° along the circumferential direction around the light channel. The jet nozzle can have a lateral incidence angle. The lateral incidence angle describes the inclination of the jet nozzle in relation to a workpiece about an advance axis along which the direction of advance runs. The lateral incidence angle therefore runs laterally to the direction of advance. The jet nozzle can also have a posterior incidence angle. The posterior incidence angle indicates the inclination of the jet nozzle versus the direction of advance. The posterior incidence angle therefore runs in or against the direction of advance. The jet nozzle can have at least two injector guides that are opposite each other. In particular embodiments, it can have four or more injector guides.

The jet nozzle can thus provide increased variability in (i) laser beam guidance, (ii) the use of a powdered filler material, (iii) heat management, (iv) protection of the laser system including the jet nozzle. It enables the provision of several independent process zones with high precision. The process zones can be divided into zones for laser cladding and zones for pre- and/or post-processing. In the zones for laser cladding, an interaction takes place between at least one laser beam and a powdered filler material. The pre- and/or post-processing can be the cleaning of the material surface, the pre-heating of the material surface before the powdered filler material is applied, the post-heating of the material surface after the powdered filler material has been applied, or a combination thereof. During pre- and/or post-processing, the laser beam can strike the workpiece without interacting with the powdered filler material. The independent process zones can increase the welding quality and thus the resilience of the applied functional layer, in particular embodiments the wear protection layer, and of the workpiece as a whole. An additional process gas can stabilize the process zones and increase the precision of laser cladding as well as the service life of the jet nozzle. Furthermore, the opposing injector guides can help to ensure that the functional layer is applied to the surface of the workpiece smoothly, i.e., without any waviness, and that the stability of the jet nozzle is increased.

In particular embodiments, the jet nozzle can reduce the occurrence of bonding defects. This is because bonding defects can occur if the surface heated by the laser beam, such as when the workpiece or a previously welded-on functional layer, has not been sufficiently heated. This lack of heating can be the result of the laser power of a single laser beam being kept low to avoid overheating the powdered filler material. The increased variability of the laser beam guidance, the increased variability of the application of a powdered filler material and/or the increased variability of the heat management of the jet nozzle can reduce or even prevent the occurrence of bonding errors, in particular embodiments by the opposing injector guides, thus enabling the equalized application of different flows of the jet of powder.

In particular embodiments, the jet nozzle can also reduce the occurrence of pores between the welded-on functional layer and the surface heated by the laser beam. This is because pores can occur when lamellae in the workpiece, in particular embodiments graphite lamellae, are vaporized by the laser radiation. Pores can also occur if the surface to be machined has impurities, for example caused by oils, greases, cooling lubricants or oxides, which cannot be completely removed by the welding process. The undesired vaporization of the impurities can be the result of the laser power of a single laser beam being set so high that bonding defects due to insufficient heating can be avoided. The increased variability of the laser beam guidance, the increased variability of the application of a powdered filler material and/or the increased variability of the heat management of the jet nozzle can reduce or even prevent the occurrence of pores, in particular embodiments by the opposing injector guides, thus enabling the equalized application of different flows of the jet of powder.

In particular embodiments, the jet nozzle can also reduce the occurrence of cracks in the welded-on functional layer. This is because cracks can occur if a temperature gradient between the highly heated powdered filler material and the less strongly heated workpiece surface is so strong that the material shrinkage that occurs during cooling results in stresses that cause cracks. Cracking can be the result of a laser power of a single laser beam being set so high that bonding defects due to insufficient heating can be avoided. The increased variability of the laser beam guidance, the increased variability of the application of a powdered filler material and/or the increased variability of the heat management of the jet nozzle can reduce or even prevent the occurrence of cracks, in particular embodiments by allowing the opposing injector guides to equalize the application of different flows of the jet of powder.

In particular embodiments, the jet nozzle can also reduce the dissolution of hard material particles, especially carbides, in the matrix material. The powdered filler material can contain hard material particles, in particular embodiments carbides, and a matrix material. The hard material particles should be present undissolved in the welded-on functional layer to increase the load-bearing capacity of the functional layer. However, hard material particles can dissolve if the powdered filler material is exposed to too high a radiation intensity, causing the hard material particles to melt. Dissolved hard material particles cause the welded-on functional layer to become brittle because the matrix material is less ductile, which means that stresses caused by shrinkage, for example, cannot be absorbed by the matrix material when the workpiece is cooled or loaded. The increased variability of the laser beam guidance, the increased variability of the application of a powdered filler material, and/or the increased variability of the heat management of the jet nozzle can reduce or even prevent the dissolution of hard material particles, in particular embodiments by the opposing injector guides, thus enabling the equalized application of different flows of the jet of powder.

In particular embodiments, the jet nozzle can prevent an adhesion of powder particles to the mouth of the nozzle. In principle, high process heat, reflective laser radiation, and/or a metal vapor plume can cause an adhering or even welding of filler material to the mouth of the nozzle, which can disrupt the gas and powder flows and subsequently impair the process result. The metal vapor plume is a result of the partial vaporization of the material due to the laser cladding. It can lead to scattering and/or absorption of laser radiation and consequently impair the preheating of the workpiece. This can further promote the formation of bonding defects. The increased variability of the laser beam guidance, the increased variability of the application of a powdered filler material, and/or the increased variability of the heat management of the jet nozzle can reduce or even prevent the undesired dissolution of hard material particles and the spread of the metal vapor plume, in particular embodiments by allowing the opposing injector guides to balance the application of different flows of the jet of powder.

The opposing injector guides reduce or avoid a wavy applied functional layer that deviates from the desired smooth functional layer. The waviness can result from parameter tolerances. The fact that the injector guides and subsequently the powder injectors arranged therein are at least approximately opposite each other in pairs ensures a fluidic equalization of the individual flows of the jet of powder during application of the functional layer. Furthermore, the kinematic stability of the jet nozzle is increased by the balancing element created by the opposing injector guides. The jet nozzle also helps to increase the process window in which the functional layer can be applied in a process-oriented manner by reducing the influence on the waviness caused by fluctuations in the laser power, the nozzle distance, and/or the conveying and/or nozzle gas. The powder caustic has a long expansion range in the beam direction with an approximately constant powder focus diameter. This prevents fluctuations in the coating and, in particular embodiments, waviness.

In one embodiment, the essentially opposite injector guides are point-mirrored at the first powder focus, so that two of the plurality of injector guides are opposite each other in relation to the center of the light channel. They therefore have a geometrically defined position in relation to each other. This also helps to increase the kinematic stability of the jet nozzle and further increase the corresponding process window.

In one embodiment, the plurality of injector guides is an odd number, wherein a rear injector guide, which is located at the front in the direction of advance, is the only one of the plurality of injector guides that does not have an opposing injector guide. In relation to a central axis of the jet nozzle, the rear injector guide is arranged centrally, i.e., it intersects the central axis. In this respect, the jet of powder emerging therefrom does not cause any imbalance in relation to the central axis and does not require an opposing injector guide. In an alternative embodiment, the plurality of injector guides is an even number, so that each injector guide has an opposing injector guide. This guarantees that the jet nozzle runs very smoothly during processing, which further contributes to the smooth surface of the functional layer.

In one embodiment, in a plane to which the direction of advance runs orthogonally, the first injector guide and/or the second injector guide is inclined relative to a longitudinal axis of the light channel, and in preferred embodiments inclined by an injector angle of between 10° and 25°. The individual injector guides can run in different directions. In preferred embodiments, however, none of the directions are perpendicular to the direction of advance. The jet nozzle therefore, in preferred embodiments, has no injector guides and consequently no powder injectors that are aligned to be perpendicular to the direction of advance, i.e., the tangential advance. The inclination of the injector guides and the resulting injector angles allow the properties of the functional layer to be adapted to suit the process. A longitudinal axis of the light channel, along which the laser beam runs, can be inclined in different directions relative to a perpendicular of the workpiece surface of the workpiece. The laser beam is therefore not orthogonal, for example inclined by the posterior incidence angle, aligned to the workpiece, for example to pick up reflected radiation specifically via the absorption section. Furthermore, an inclination to the lateral incidence angle can help to ensure that the functional layer can be coated geometrically right up to what is termed the hub cap of a brake disk. The hub cap can represent an interfering contour, which can cause a collision if the nozzle is aligned orthogonally to the brake disk surface.

In one embodiment, each of the plurality of injector guides is aligned with the first powder focus, wherein in particular the first powder focus lies on a longitudinal axis of the light channel along which the laser beam runs. Accordingly, the powder injectors convey their respective flow to the same point. The jet nozzle thus enables the jet of powder to be applied to the workpiece surface at the same point, which ensures the application of a high functional layer within a short period of time. The first powder focus can, for example, be located centrally in a circular opening of the light channel, or also eccentrically in a stretched opening. The injector guides or the powder injectors inserted therein can have a common focus or focus range, for example on a laser secondary symmetry axis.

In one embodiment, a first part of the plurality of injector guides is aligned with the first powder focus and a second part is aligned with a second powder focus, wherein in particular the first powder focus and the second powder focus run along the direction of advance and thus form a focus line. The injector guides thus form two powder foci, which favors uniform application of the functional layer along the direction of advance. Those injector guides that are arranged in the region of the first powder focus can be aligned with the first powder focus and those that are arranged in the region of the second powder focus can be aligned with the second powder focus. This ensures local and functional separation of the individual injector guides, which further enhances the fluidic properties of the jet nozzle.

In one embodiment, a first powder injector is inserted into the first injector guide and prepared to convey a first powder mass flow and a second powder injector is inserted into the second injector guide and prepared to convey a second powder mass flow, wherein the first powder mass flow differs from the second powder mass flow. The first powder injector can be provided opposite the second powder injector. The first powder injector can be arranged in such a way that it interacts with a primary beam of the laser beam. The second powder injector can be arranged in such a way that it interacts with a secondary beam of the laser beam. The primary beam and the secondary beam can be identical to each other or can transport different energy. The provision of the first powder mass flow and the second powder mass flow enables the jet nozzle to realize more than one process zone, which further contributes to increased variability of the jet nozzle. In particular embodiments, the first powder mass flow conveys a powder that differs from the second powder mass flow. This allows a functional layer with variable materials to be applied to the workpiece. Alternatively, the first powder mass flow and the second powder mass flow can direct the same powder onto the workpiece. Adjusting the powder mass flow to the injectors to be supplied further contributes to increased variability.

In one embodiment, a cross-sectional area of the light channel extending orthogonally to the longitudinal direction of the jet nozzle is stretched in the direction of advance, deviating from a circular shape, and the powder section extends along an elongated hole arc, in particular in a horseshoe shape, around the light channel. Analogous to a circular arc, the elongated hole arc represents a line surrounding the elongated hole in a sector. The remaining part of the elongated hole that is not covered by the elongated hole arc along which the powder section extends can be filled by the advance section. The powder section can extend at least partially along the two opposite, straight ends of the elongated hole and the intermediate partial circular section to form the horseshoe shape. This further contributes to the fact that more than one process zone can be provided. At least one laser beam, and in particular embodiments at least one circular laser beam and/or an oval laser beam, can be guided along the stretched cross-sectional area of the light channel in such a way that more than one process zone is formed, which favors the welding behavior and reduces the imperfections of the welded joint, in particular embodiments the occurrence of bonding defects, pores, cracks and/or the dissolution of carbides in the matrix material, and increases the load-bearing capacity of the applied functional layer. This means that the melting behavior, jet of powder behavior, material bonding and cooling behavior can be variably adapted to the respective application and the prevailing material properties and process parameters.

In one embodiment, the powder section is composed of a first powder section and a second powder section, and the first powder section is separated from the second powder section by a powder section gap. The first and second powder sections can efficiently realize the opposite injector guides. Each injector guide in the first powder section can have an opposing, corresponding injector guide in the second powder section. The sum of the angles of the first powder section and the second powder section can form a wrap angle. In the embodiment in which the powder portion is composed of the first powder portion and the second powder portion, when it reaches certain angular spans as shown below, these angular spans are composed of the sum of the angular portion of the first powder portion and the angular portion of the second powder portion.

In one embodiment, the powder section extends in the circumferential direction around the light channel by a wrap angle of between 45° and 330°, in particular embodiments between 90° and 300°, further in particular embodiments between 180° and 300°, relative to a center of the light channel. The wrap angle can be optimized in such a way that one injector guide can have an opposite injector guide. The powder section can therefore extend by a larger section around the light channel than the advance section. In this way, a satisfactory powder supply can be ensured by the powder unit and, in particular embodiments, the injectors arranged therein. A precise adjustment of the powder section and the advance section to the respective process conditions enables efficient welding behavior without imperfections. In particular embodiments, if the mouth of the nozzle has a chamfer that cuts off part of the mouth of the nozzle, the wrap angle of the powder section is between 90° and 180°. If the mouth of the nozzle has no chamfer, the mouth of the nozzle is, in preferred embodiments, above 180°. In the embodiment in which the powder section is composed of a first powder section and a second powder section, the wrap angle represents the sum of the angles of the first powder section and the second powder section.

In one embodiment, the light channel is adapted to guide a plurality of laser beams, wherein the plurality has a first laser beam as a primary beam and a second laser beam as a secondary beam. The primary beam and the secondary beam can originate from the same optical fiber cable. The laser light provided can be split into a parallel beam via a collimating lens. The beam bundle can, for example, form the primary beam and the secondary beam from a single laser beam using a wedge plate. In this case, the primary beam and the secondary beam can have the same wavelength and transport the same energy. Alternatively, the primary beam and the secondary beam can differ in terms of their wavelength and energy. The respective centers of the primary beam and the secondary beam can be offset in line with a center of the light channel in the direction of advance. The provision of multiple laser beams favors the reliable implementation of several process zones.

In one embodiment, a powder unit-free advance section adjoins the powder section in the circumferential direction, which is formed in a region of the mouth of the nozzle facing the direction of advance. The powder section and the advance section can together form the entire circumference of the mouth of the nozzle around the light channel. For example, the powder section can make up the larger part than the advance section. In the plan view, the powder section and the advance section can run closed along an opening of the light channel. In a plan view, the region of the mouth of the nozzle facing the direction of advance is provided at the end of the nozzle that is close to the direction of advance. One end face of the advance section points in the direction of the workpiece. The advance section can extend along the circumferential direction around the light channel in an angular range. The angular range in which the advance section extends can be smaller than the angular range in which the powder section extends. The region in which the advance section is formed can correlate with the position and orientation of the injector guides and the powder injectors that apply the powdered filler material to the workpiece. The division into a powder section and an advance section can also create a gap in the powder caustic, which further contributes to the different process zones. The division into a powder section and an advance section enables a welding behavior without the aforementioned imperfections.

In one embodiment, a process gas unit for conducting a process gas is arranged radially outside the light channel, wherein the process gas unit forms a process gas section in the circumferential direction, which occupies the advance section. Starting from the longitudinal direction of the jet nozzle, the process gas unit can be radially outside the light channel and can be part of the outer structure that surrounds the light channel in a closed manner. The process gas can positively influence the powder caustic and the workpiece processing caused thereby. The process gas unit can be the part of the jet nozzle that is provided to guide the process gas directly or indirectly. The process gas unit can have additional injector guides into which additional injectors can be inserted. It can also have an annular gap within which the process gas is guided. At the mouth of the nozzle, the process gas unit forms the process gas section in a circumferential direction around the light channel. The process gas unit can be part of the mouth of the nozzle. In the plan view, the process gas section can run at least in sections along the opening of the light channel. The process gas section can be the part of the process gas unit from which the process gas emerges from the jet nozzle. The process gas section can connect to the powder section at the mouth of the nozzle in the circumferential direction. This means that the process gas section can be directly adjacent to the powder section in the circumferential direction. This allows the process gas to have a stabilizing effect on the powder caustic and the continuous laser cladding. The process gas section can be connected to the powder section in such a way that a transition takes place in the circumferential direction so that an interior is separated from the process gas section and the powder section from an exterior. The separation can be such that as little fluid as possible is exchanged between the inside and the outside. This can help to stabilize the process zones, and at the same time prevent the powder particles from sticking to one end face of the jet nozzle, thus increasing the service life of the jet nozzle.

In one embodiment, the jet nozzle is manufactured by means of an additive manufacturing process, in particular by means of powder bed fusion. For this purpose, the jet nozzle can be made of copper or a copper alloy, in particular embodiments a copper-chromium-zirconium alloy. This is suitable for additive manufacturing processes on the one hand and ensures sufficient strength, thermal conductivity, and heat resistance to withstand the process requirements on the other. In powder bed fusion, the material to be processed is in powder form. A laser beam heats the powder along the provided geometry, causing the powder to liquefy and form a material bond. The powder bed fusion can be formed using selective laser melting (SLM) or selective laser sintering (SLS), for example. The jet nozzle can be made of a non-ferromagnetic and/or non-ferromagnetizable material.

In one embodiment, the mouth of the nozzle has a chamfer by which a part of the mouth of the nozzle is cut off, wherein the chamfer is essentially planar and extends in a plane which is inclined relative to the longitudinal direction of the jet nozzle. The chamfer can cut off the powder section and the powder section-free advance section or the process gas section in the circumferential direction around the light channel. The chamfer reduces the volume of the mouth of the nozzle compared to the embodiment in which no chamfer is provided. This means that the mouth of the nozzle takes up less installation space. The jet nozzle with the chamfer can be used, for example, to coat a brake disk that has a mount, i.e., a hub cap, that protrudes axially from the functional surface to be coated. The chamfer ensures that the jet nozzle can move flexibly on the functional surface to be coated and can be moved close to the holder. The chamfer can run in the distal region like a passant on the elongated hole or the circular opening. The passant defines the orientation of the chamfer on the mouth of the nozzle. In the end face of the jet nozzle facing the workpiece, the passant runs along a straight line or an arc that neither intersects nor touches the elongated hole. The distance of the passant from the center of the light channel is greater than the distance of the corresponding section of the elongated hole from the center of the light channel. The distance between the passant and an outer edge of the elongated hole is selected in such a way that the wall thickness in between ensures sufficient sturdiness and stressability of the jet nozzle. The mouth of the nozzle can also have two chamfers that are arranged symmetrically at the mouth of the nozzle. In particular embodiments, the chamfer is provided on the side of the mouth of the nozzle facing the hub cap to increase the lateral incidence angle of the jet nozzle relative to the perpendicular of the workpiece surface.

In one embodiment, the process gas unit forms at least one outlet opening on one end face of the jet nozzle, from which the process gas can be fed to the workpiece, wherein an additional injector for supplying the process gas without additional filler material is arranged in the at least one outlet opening. The outlet opening can be designed on the end face in such a way that the surface to which hard material particles can adhere is minimized. The process gas that is fed out of the outlet opening can be supported by the process gas that is fed inside the light channel. An additional injector can be arranged in each outlet opening. The additional injector differs from the injectors arranged in the injector guides of the powder unit. The latter transport the hard material particles to the workpiece surface, while the former transport the process gas.

In one embodiment, the process gas section extends at least in sections along an elongated hole arc, in particular in the shape of an arc, around the light channel. Analogous to a circular arc, the elongated hole arc represents a line surrounding the elongated hole in a sector. The remaining part of the elongated hole that is not covered by the elongated hole arc along which the process gas section extends can be filled by the powder section. The process gas section can extend at least partially along a partial circular section, in particular embodiments the partial circular section that lies at the front in the direction of advance, to form the arc shape. This also helps to stabilize the laser beam guidance and/or the powder caustic.

In one embodiment, the process gas section extends in the circumferential direction around the light channel by a wrap angle of between 5° and 180°, in particular between 45° and 120°, relative to a center of the light channel. This means that the process gas section can extend around the light channel by a smaller section than the powder section. This ensures a satisfactory supply of powder through the powder unit and, in particular embodiments, the injectors arranged therein, while avoiding adhesion or spreading of the vapor plume. Precise adaptation of the powder section and the process gas section to the respective process conditions enables efficient welding behavior without imperfections.

In one embodiment, the process gas section and the powder section together completely surround the light channel in the circumferential direction, i.e., by 360°. The jets emerging from the process gas section and the powder section can thus separate an interior, which is formed inside the jets, and an exterior, which is formed outside the jets. The metal vapor plume, also known as a vapor plume, resulting from the interaction of the powder particles with the laser beam cannot escape from the interior in this way, which prevents unwanted interaction of the vapor plume with the workpiece.

In one embodiment, an end face of the jet nozzle or the end face from the above embodiment runs at an angle to the longitudinal axis of the light channel along which the laser beam runs, so that the end face is provided to run essentially in a plane-parallel manner to a workpiece surface. This means that the distance from the mouth of the nozzle to the workpiece can be increased when the nozzle is angled. This reduces the thermal load on the mouth of the nozzle. In addition, the angled end face enables improved shielding gas coverage of the workpiece. The plane-parallel surface of the end face enables a shielding gas flow that exits orthogonally to the workpiece. In one embodiment, the jet nozzle is adapted to guide the laser beam along the longitudinal direction of the jet nozzle so that the at least one laser beam is orthogonal to the cross-sectional surface. Furthermore, the light channel can be adapted to guide a shielding gas along a radially outer section to shield a process zone.

In one embodiment, the disclosure further relates to a system comprising a jet nozzle according to the disclosure and a workpiece. The jet nozzle is inclined about an advance axis, along which the direction of advance runs, to form a lateral incidence angle with respect to the workpiece, so that in a plane to which the direction of advance runs orthogonally, a longitudinal axis of the light channel, along which the laser beam runs, deviates from a perpendicular of a workpiece surface of the workpiece The lateral inclination can be realized by a relative movement of the jet nozzle to the workpiece or of the workpiece to the jet nozzle. For example, a workpiece support can be inclined in relation to the jet nozzle. The lateral inclination can be selected in such a way that the fluidic balance of the individual flows of the jet of powder is optimized when applying the functional layer. The system can have powder injectors. A powder injector can be inserted in each injector guide. In particular embodiments, the jet nozzle and/or the powder injectors are made of a non-ferromagnetic material or a non-ferromagnetizable material.

In one embodiment the lateral incidence angle is between 2° and 45°, in particular between 5° and 30°, in particular between 10° and 25°. At these incidence angles, a smooth functional layer that is free of waviness can be realized efficiently. These incidence angles with the opposing arrangement of the injector guides further contribute to the avoidance of imperfections in the functional layer. It has also been found that these incidence angles achieve an ideal compromise between the absorption of reflected radiation via the jet nozzle and the welding behavior of laser cladding.

In one embodiment, at least one, in particular each, of the plurality of injector guides, in particular the first injector guide and/or the second injector guide, is inclined relative to the longitudinal axis of the light channel in a plane to which the direction of advance is orthogonal, preferably inclined by an injector angle of between 10° and 25°, wherein an angular sum of the lateral incidence angle and the injector angle is such that an injector guide inclined towards the workpiece encloses a workpiece angle of at most 30°, in particular at most 45°, further in particular at most 50° with the workpiece. The sum of the lateral incidence angle and the injector angle means that the injector guide inclined towards the workpiece is at a later angle to the workpiece than other injector guides. If the material angle of the injector guide inclined towards the workpiece is too acute, the functional layer applied by that injector can suffer. In this embodiment, the workpiece angle should therefore not be less than 30°. In particular embodiments, the lateral incidence angle and the injector angle are matched to each other in such a way as to avoid falling below the workpiece angle. In this way, an optimum ratio of high-quality functional layer, functional layer applied close to a hub cup, and efficient processing time can be achieved.

Embodiments further relate to a method for laser cladding along a direction of advance, in particular embodiments by means of a jet nozzle or system according to the present disclosure. The method includes the step of aligning the jet nozzle with a workpiece. As soon as the jet nozzle is aligned with the workpiece, the laser cladding process can begin. The method further comprises the step of inclining the jet nozzle about an advance axis along which the direction of advance extends, so that the jet nozzle forms a lateral incidence angle of less than 90° relative to the workpiece in a plane to which the direction of advance is orthogonal. This ensures that the jet nozzle can be brought close to a hub cup, for example. In particular embodiments, in combination with the jet nozzle according to the disclosure and the opposing injectors, the method is suitable for realizing a smooth and large-area functional layer on brake disks having a hub cup.

In one embodiment of the method, the jet nozzle is inclined in such a way that an injector guide inclined towards the workpiece encloses a workpiece angle of at most 30°, in particular at most 45°, further in particular at most 50° with the workpiece. If the material angle of the injector guide inclined towards the workpiece is too acute, the functional layer applied by that injector can suffer. In this embodiment, the workpiece angle should therefore not be less than 30°. In this way, an optimum ratio of high-quality functional layer, functional layer applied close to a hub cup, and efficient processing time can be achieved.

The features according to the disclosure contribute partly on their own and partly in combination to overcoming the imperfections of laser cladding mentioned at the outset.

Preferred further embodiments of the invention are explained in greater detail by way of the following description of the figures.

Preferred exemplary embodiments are described below with reference to the figures. In this case, elements that are the same, similar, or have the same effect are provided with identical reference symbols in the different figures, and a repeated description of these elements is omitted in some instances to avoid redundancies.

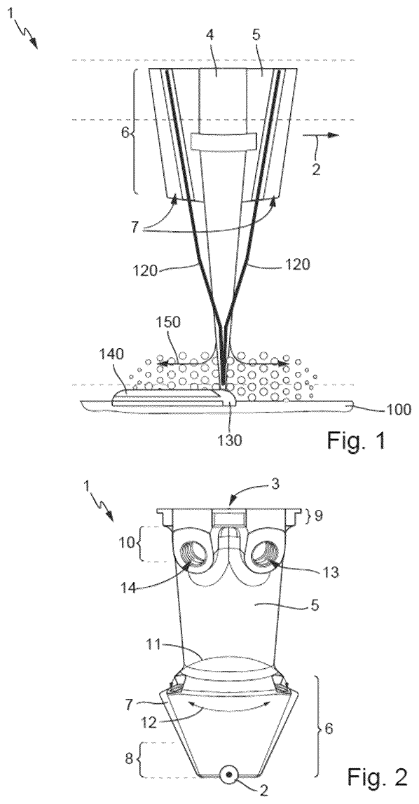

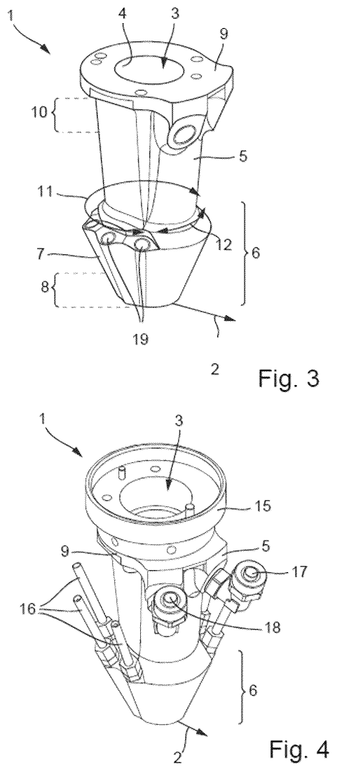

FIG. 1 shows a jet nozzle 1 for laser cladding along a direction of advance 2. The direction of advance 2 is the direction along which the jet nozzle 1 moves relative to a workpiece 100. It can result from a movement, in particular a rotational movement, of the workpiece 100, from a movement of the jet nozzle 1 or from a superimposition of a movement of the workpiece 100 and the jet nozzle 1. The direction of advance 2 and the correlating advancement movement can be constant over the course of the process. Alternatively, they can vary with the respective process stage. The workpiece 100 can be a rotationally symmetrical workpiece, such as a brake disk, a hydraulic cylinder, a pressure roller, or a plain bearing. At least one laser beam 110 emerges from a light channel 3 with a lateral surface 4. The light channel 3 can also be adapted to guide a process shielding gas 150 along a radially outer section to shield a process zone and prevent oxidation. The light channel 3 is surrounded by an outer structure 5, which has a mouth of the nozzle 6, which in turn contains a powder unit 7. The powder unit 7 can, for example, have a plurality of injector guides 19 (see FIG. 3), into each of which can be inserted a powder injector 16 (see FIG. 4). As an alternative to the individual injector guides 19, the powder unit 7 can have a powder ring gap channel. A powdered filler material 120 is directed onto the workpiece 100 via the powder unit 7 and the powder injectors 16 arranged therein. The laser beam 110 heats the workpiece 100 in such a way that a molten pool 130 forms on a material surface. In addition, the laser beam 110 heats the powdered filler material 120, which comprises hard material particles and a matrix material. For this purpose, the laser beam 110 can have a reduced core intensity. As soon as the molten pool 130 cools down, a welded-on functional layer 140, for example a wear protection layer, is formed from the hard material particles and the matrix material. The welded-on functional layer 140 makes the material surface more resistant and increases its load-bearing capacity.

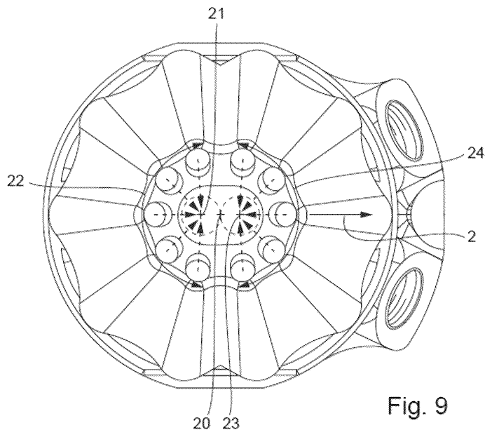

FIG. 2 shows the jet nozzle 1 in a side view, with the direction of advance 2 pointing out of the drawing plane. The jet nozzle 1 can be coupled to other components of a laser system, such as laser optics or a process adapter, via a flange section 9. A proximal region 10 is attached to the flange section 9. A coolant inlet 13 and a coolant outlet 14, which are part of a cooling system of the jet nozzle 1 and which project radially from the jet nozzle 1, can be provided at least partially in the proximal region 10. A distal region 8 is formed at the end of the jet nozzle 1 opposite the proximal region 10. The distal region is part of the funnel-shaped mouth of the nozzle 6. In a circumferential direction around the light channel 3, this has a powder section 11 in sections, in which the powder unit 7 is arranged. The powder section 11 is followed in the circumferential direction by a powder unit-free advance section 12. The advance section 12 can be designed as a process gas section 61 (see, for example, FIG. 9), which is part of a process gas unit 60.

FIG. 3 shows a perspective view of the jet nozzle from FIG. 2. The light channel 3 is a hollow channel with a lateral surface 4, within which runs the at least one laser beam 110. The outer structure 5 surrounds the light channel 3 from the flange section 9 to the distal region 10. The mouth of the nozzle 6 is an essentially funnel-shaped region of the jet nozzle 1. The funnel shape of the mouth of the nozzle 6 serves, among other things, to enable the mouth of the nozzle 6 to form the plurality of injector guides 19 in the region of the powder unit 7. A powder injector 16 (see FIG. 4) is inserted into each of these injector guides 19, which directs the powdered filler material 120 onto the at least one laser beam 110 and/or the workpiece 100 in accordance with the process. The powder unit 7 extends along the powder section 11, which is followed in the circumferential direction by the powder unit-free advance section 12. The advance section 12 is the region of the mouth of the nozzle 6 in which no injector guides 19 are provided, so that no powdered filler material 120 is supplied via this section. In one embodiment, the advance section 12 can be shaped as a process gas section 61, so that a process gas is supplied via this. The jet nozzle 1 can be manufactured by means of additive manufacturing processes, in particular by means of powder bed fusion. For this purpose, the jet nozzle 1 can be made of a copper-chromium-zirconium alloy. This is suitable for additive manufacturing processes on the one hand and ensures sufficient strength, thermal conductivity, and heat resistance to withstand the process requirements on the other. In powder bed fusion, the material to be processed is in powder form. A laser beam heats the powder along the provided geometry, causing the powder to liquefy and form a material bond. The powder bed fusion can be formed using selective laser melting (SLM) or selective laser sintering (SLS), for example.

FIG. 4 shows the jet nozzle 1, to which additional components are attached. A coupling ring 15 is connected to the flange section 9, which attaches the jet nozzle 1 to the connected unit, for example the laser optics or the process adapter. Powder injectors 16 are inserted into the injector guides 19 of the powder unit 7. The powdered filler material 120 is conveyed by means of the powder injectors 16 and applied to the workpiece 100 with the provided focus. The individual powder injectors 16 can use different powder foci in relation to each other. Alternatively, the powder injectors 16 can be directed to the same focus point. The powder injectors 16 are arranged in the provided injector guides 19 of the powder unit 7 in the powder section 11. The advance section 12 is free of powder injectors 16. An inlet connection 17 is also inserted into the coolant inlet 13 and an outlet connection 18 is inserted into the coolant outlet 14. These connect the coolant inlet 13 and the coolant outlet 14 to a coolant circuit.

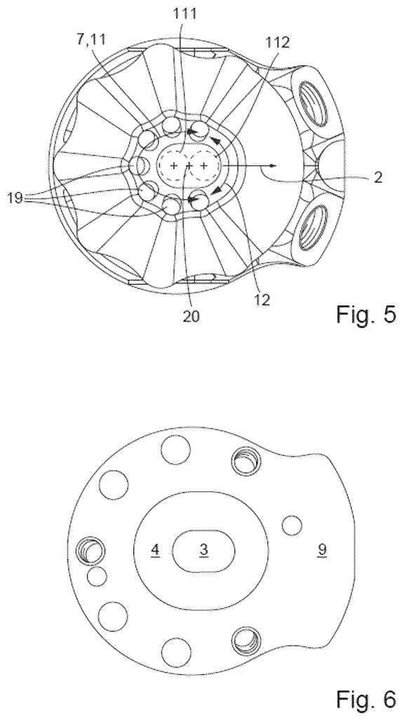

FIG. 5 shows the jet nozzle 1 in a top view of the distal region 8. The cross-sectional area of the light channel 3, which is orthogonal to the longitudinal direction of the jet nozzle 1, deviates from a circular shape and is stretched in the direction of advance 2. In the distal region 8, the cross-sectional area of the light channel 3 is designed in the form of an elongated hole, in which two opposite ends of a rectangular section are each joined by a partial circular section. Two laser beams are guided within the light channel 3, a primary beam 111 and a secondary beam 112. The primary beam 111 and the secondary beam 112 can originate from the same optical fiber cable. The laser light provided can be split into a parallel beam via a collimating lens. The beam bundle can, for example, form the primary beam 111 and the secondary beam 112 from a single laser beam using a wedge plate. The respective centers of the primary beam 111 and the secondary beam 112 lie in the direction of advance 2 in a line offset to a center 20 of the light channel 3.

In the present case, the secondary beam 112 lies in front of the primary beam 111 in the direction of advance 2 and does not interact with a powder caustic. The secondary beam 112 can thus be used to preheat the workpiece 100 before the primary beam 111 and the powdered filler material 120 heated by the primary beam 111 strike the workpiece 100. The secondary beam 112 thus creates a first process zone, which serves to preheat the workpiece 100, and the primary beam 111 creates a second process zone, which serves to weld the powdered filler material 120 onto the workpiece 100. These different process zones enable a flawless weld in which no imperfections occur, in particular no bonding defects, pores, cracks and/or dissolution of carbides in the matrix material. It is also possible to guide the secondary beam 112 in the direction of advance 2 after the primary beam 111. Thus, the secondary beam 112 can be used to reheat the workpiece 100, contributing to a more uniform cooling that prevents the occurrence of entrapment or other imperfections.

The primary beam 111 and the secondary beam 112 are arranged in close proximity to each other. The front partial circular section of the elongated hole in the direction of advance 2 is concentric to the secondary beam 112, while the rear partial circular section of the elongated hole is concentric to the primary beam 111. A center of the cross-sectional area is eccentric to a center of the primary beam 111 and to a center of the secondary beam 112. A tertiary beam can also be provided so that, for example, the secondary beam is arranged before the primary beam in the direction of advance and the tertiary beam is arranged after the primary beam in the direction of advance. The individual laser beams are guided to each other without shielding, so that there is exactly one light channel 3 with exactly one lateral surface 4, which results in minimal thermal losses.

Because the primary beam 111 in FIG. 5 is arranged behind the secondary beam 112 in the direction of advance 2 without radial offset and the secondary beam 112 serves to preheat the workpiece, it is desirable that the powdered filler material does not interact with the secondary beam 112. This ensures that, on the one hand, the secondary beam 112 can only perform the function of preheating the workpiece and, on the other hand, the powdered filler material is only heated by the primary beam 111 and not by the secondary beam 112. This is achieved by the jet nozzle 1 shaping the powder unit 7 in the region of the mouth of the nozzle 6 in such a way that it forms the powder section 11 in the circumferential direction around the light channel 3, to which the powder unit-free advance section 12 is connected in the circumferential direction. In addition to the powder unit 7, the process gas unit 60 can also be formed, which forms the process gas section 61, in which case the advance section 12 is formed as the process gas section 61. The advance section 12 is formed in a region of the mouth of the nozzle 6 facing the direction of advance 2. The powder section 11 extends along the elongated hole that forms the cross-sectional area of the light channel 3 in the distal region 8. Similar to a circular arc, the powder section 11 extends along an elongated hole arc, in particular in the shape of a horseshoe, around the light channel 3. The powder section 11 therefore extends in the circumferential direction around the light channel 3 by a wrap angle of less than 360°, in particular between 90° and 330°, further in particular between 180° and 300°, relative to a center of the light channel. This ensures that the powdered filler material flowing out of the injectors 16, which are inserted in the injector guides 19, only interacts with the primary beam 111. The secondary beam 112 can thus form a process zone independent of the primary beam 111. The powder section 11 and the advance section 12 form an elongated hole shape when viewed from above. This also helps to reduce or avoid the imperfections identified at the outset.

FIG. 6 shows the jet nozzle 1 in a top view of the flange section 9. The cross-sectional area of the light channel 3, which is orthogonal to the longitudinal direction of the jet nozzle 1, also deviates from a circular shape in the region of the flange section 9 and is stretched in the direction of advance 2. The elongation of the cross-sectional area can decrease from the distal region 8 to the flange section 9. In the region of the mouth of the nozzle 6, the cross-sectional area can be stretched in such a way that it is at least 1.5 times larger in the direction of advance, in particular at least twice as large as transverse to the direction of advance. The flange section 9 has such a radial extension that the injector guides 19 are not visible from the top view of the proximal region 10.

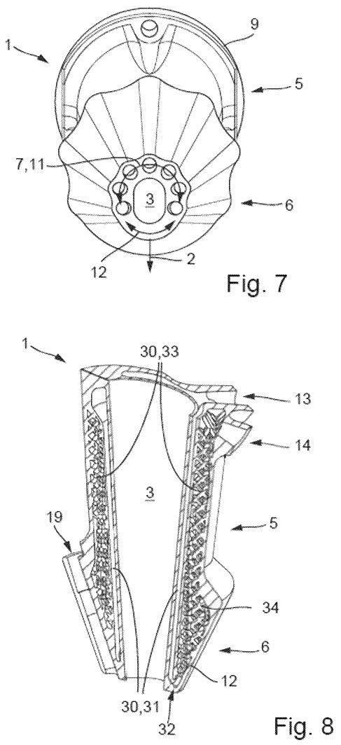

FIG. 7 shows the jet nozzle 1 in a further perspective view. The mouth of the nozzle 6 has a curved funnel shape. The injector guides 19, into which the powder injectors 16 can be inserted, are formed within the individual curvatures. In the direction of advance 2, the light channel is stretched in a way that deviates from a circular shape to achieve the advantages according to the disclosure. In the circumferential direction around the light channel 3, the mouth of the nozzle 6 has the powder unit 7. This extends in the circumferential direction around the light channel 3 along the powder section 11, which is adjoined by the powder-free advance section 12.

FIG. 8 shows a perspective sectional view of the jet nozzle 1. The light channel 3 has a conical shape, so that the cross-sectional area of the light channel 3 running orthogonal to the longitudinal direction of the jet nozzle 1 is smaller in the distal region 8 than in the proximal region 10. The coolant inlet 13 and the coolant outlet 14 are arranged in the proximal region 10 of the jet nozzle 1 and protrude in a radial direction from the jet nozzle 1. FIG. 8 shows a sectional view of an injector guide 19. This is arranged in the powder section 11. No injector guide 19 for guidance of the jet of powder is provided in the advance section 12. The jet nozzle 1 has a cooling system 30. A cooling medium, for example water, is fed back to a radially inner cooling chamber 31 via the coolant inlet 13 in the proximal region 10. The cooling medium can be distributed in the proximal region 10 in the circumferential direction around the light channel 3. The cooling medium runs from the proximal region 10 to the mouth of the nozzle 6. The radially inner cooling chamber 31 is formed at least in the mouth of the nozzle 6. It can extend from the distal region 8 to the proximal region 10 and be designed in the form of an annular gap segment that extends around light channel 3. In the region of the mouth of the nozzle 6, the radially inner cooling chamber 31 extends circumferentially about the light channel 3. The radially inner cooling chamber 31 has a constant width in the radial direction in the region of the mouth of the nozzle 6 and is concentric to the light channel 3 in a cross-sectional area extending orthogonally to a longitudinal direction of the jet nozzle 1.

A transition 32 between the radially inner cooling chamber 31 and a radially outer cooling chamber 33 is provided in the distal region 8. The radially outer cooling chamber 33 has a radial width that decreases towards the distal region 8 in the radial direction in the region of the mouth of the nozzle 6. The radially outer cooling chamber 33 extends from the distal region 8 to the proximal region 10, where it feeds the heated coolant to the coolant outlet 14. The transition 32 between the radially inner cooling chamber 31 and the radially outer cooling chamber 33 is arranged in the advance section 12. The advance section 12 has no injector guides 19 for guidance of the jet of powder beam, which means that there is sufficient installation space for the transition 32.

The radially outer cooling chamber 33 has a cooling structure to increase the surface area. The cooling structure can be produced by means of an additive manufacturing process. It ensures that the cooling medium comes into contact with as much surface area as possible when returning from the distal region 8 to the proximal region 10 to promote heat dissipation. The cooling structure is optimized to cause the lowest possible pressure loss of the cooling medium. This can be achieved by a honeycomb structure 34, as shown in FIG. 8.

FIG. 9 shows the jet nozzle 1 of a further embodiment in a top view of the distal region 8. The cross-sectional area of the light channel 3, which is orthogonal to the longitudinal direction of the jet nozzle 1, deviates from a circular shape and is stretched in the direction of advance 2. In the distal region 8, the cross-sectional area of the light channel 3 is designed in the form of an elongated hole, in which two opposite ends of a rectangular section are each joined by a partial circular section. The primary beam 111 and the secondary beam 112 are guided within the light channel 3. The respective centers of the primary beam 111 and the secondary beam 112 are offset in the direction of advance 2 in a line to the center 20 of the light channel 3.

The primary beam 111 has a beam center that coincides with a first powder focus 21. The first powder focus 21 is the point on which the injectors of a first powder section 22 are focused. The first powder section 22 forms a first powder caustic. Accordingly, the secondary beam 112 has a beam center that coincides with a second powder focus 23. The second powder focus 23 is the point on which the injectors of a second powder section 24 are focused. The second powder section 24 forms a second powder caustic. The primary beam 111 and the secondary beam 112 are offset in relation to each other in the direction of advance 2. Accordingly, the first powder focus 21 is also offset from the second powder focus 23. The powder unit 7, which has the first powder section 22 and the second powder section 24, can thus form two powder foci that differ from one another. In addition, a powder mass flow that is conveyed from the injectors of the first powder section 22 can differ from a powder mass flow that is conveyed from the injectors of the second powder section 24. A gap can be provided between the first powder section 22 and the second powder section 24, so that the powder mass flow applied by the first powder section 22 interacts exclusively with the primary beam 111 and the powder mass flow applied by the second powder section 24 interacts exclusively with the secondary beam 112.

The first powder section 22 and the second powder section 24 contribute to an increase in the application rate by realizing at least two process zones within the jet nozzle 1. This can increase the track width of the applied functional layer. In addition, improved shielding gas coverage is achieved with lower shielding gas consumption, as the shielding gas can be more localized.

The primary beam 111 and the secondary beam 112 are arranged in close proximity to each other. The front partial circular section of the elongated hole in the direction of advance 2 is concentric to the secondary beam 112, while the rear partial circular section of the elongated hole is concentric to the primary beam 111. The center 20 of the cross-sectional area is eccentric to the center of the primary beam 111 and to the center of the secondary beam 112.

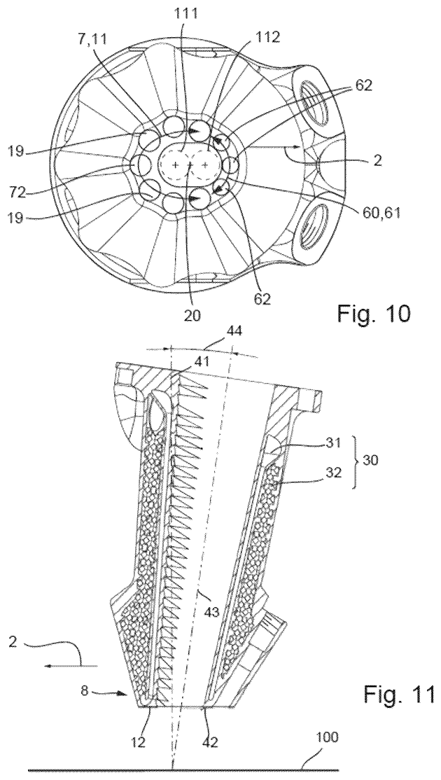

FIG. 10 shows the jet nozzle 1 in a top view of the distal region 8. The primary beam 111 and the secondary beam 112 are guided within the light channel 3. The secondary beam 112 is in front of the primary beam 111 in the direction of advance 2 and does not interact with a powder caustic, as described in more detail in connection with FIG. 5. When the laser beams interact with the material surface and the jet of powder, a vapor plume can form between the jet nozzle 1 and the workpiece 100. If this is not contained, it can interact with at least one laser beam and/or the unprocessed and/or processed material surface in an undesirable manner. In the region adjacent to the powder section 11, the advance section 12 can therefore be designed as a process gas section 61. This is formed by the process gas unit 60 being arranged radially outside the light channel 3, which directs the process gas onto the workpiece. The process gas section 61 can prevent undesired spreading of the vapor plume and thus contribute to precise workpiece processing with a robust jet nozzle design. The process gas section 61 can form at least one, in the present case three, outlet openings 62. The outlet openings 62 are formed on one end face of the jet nozzle 1. An additional injector for supplying the process gas without additional material can be inserted into the respective outlet opening 62. An inner diameter of the outlet opening 62 can be smaller than an inner diameter of the injector guides 19. The process gas section 61 also prevents powder particles from adhering to the end face of the jet nozzle 1. In this respect, the process gas section 61 also increases the service life of the jet nozzle 1. The process gas section 61 and the powder section 11 can be provided circumferentially around the elongated hole formed by the light channel 3. Thus, the primary beam 111 and the secondary beam 112 are completely within the beams composed of the jet of powder and the process gas jet. The jet nozzle 1 has a plurality of injector guides 19. The injector guide, which is arranged at the end facing away from the direction of advance 2, is a rear injector guide 72.

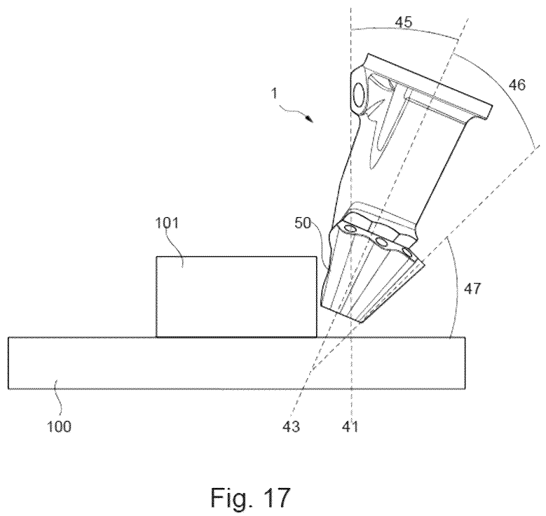

FIG. 11 shows the jet nozzle 1 with a workpiece 100 in a longitudinal section. The laser beam 110 extends along a longitudinal axis 43 of the light channel 3. The longitudinal axis 43 of the light channel 3 is inclined by a posterior incidence angle 44 relative to a perpendicular of the workpiece surface 41. The posterior incidence angle 44 describes the inclination of the jet nozzle 1 versus the direction of advance 2. This posterior inclination directs a reflected laser beam onto an absorption section, for example. In addition to the posterior inclination, the jet nozzle 1 can also be laterally inclined with respect to the workpiece 100, as described further in connection with FIG. 17. The posterior incidence angle can be between 2° and 45°, in particular between 10° and 30°, in particular between 15° and 25°. To achieve the inclination or the incidence angle 44, it is possible to incline the jet nozzle 1 relative to the workpiece 100 or to incline the workpiece 100 relative to the jet nozzle 1. A surface roughness of the absorption areas of the absorption section is between 5 μm and 100 μm, in particular between 50 μm and 50 μm. The absorption section can also be provided with an absorbent coating that promotes absorption. One end face 42 of the jet nozzle 1 can run at an angle to the longitudinal axis 43 of the light channel 3 so that the end face 42 runs plane-parallel to the workpiece 100. This increases the distance from the mouth of the nozzle 6 to the workpiece 100. This reduces the thermal load on the mouth of the nozzle 6. In addition, the angled end face 42 enables improved shielding gas coverage of the workpiece 100. This is because the plane-parallel surface of the end face 42 allows a shielding gas flow to emerge orthogonally to the workpiece 100.

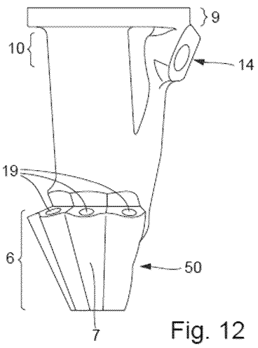

FIG. 12 shows a further embodiment of the jet nozzle 1. The mouth of the nozzle 6 has a chamfer 50, through which a part of the mouth of the nozzle 6 is cut off. The chamfer 50 has the effect that the powder section 11 and the advance section 12 without a powder section are cut off in the circumferential direction around the light channel 3. The chamfer 50 reduces the volume of the mouth of the nozzle 6 compared to the embodiment in which there is no chamfer 50. This ensures that the mouth of the nozzle 6 takes up less installation space. The jet nozzle 1 with the chamfer 50 can be used, for example, to coat a brake disk. The brake disk can have a mount that protrudes axially from the functional surface to be coated. The chamfer 50 ensures that the jet nozzle 1 can move flexibly on the functional surface to be coated and can be moved close to the holder. The chamfer 50 can be essentially flat and run in a plane that is inclined relative to the longitudinal direction of the jet nozzle. The chamfer 50 represents a boundary surface of the mouth of the nozzle 6 in which a powder unit 7 is not provided. In the distal region 8, the chamfer 50 is arranged so close to the light channel 3 that no injector guides 19 are provided on an end face of the jet nozzle 1 facing the workpiece in the region of the chamfer 50.

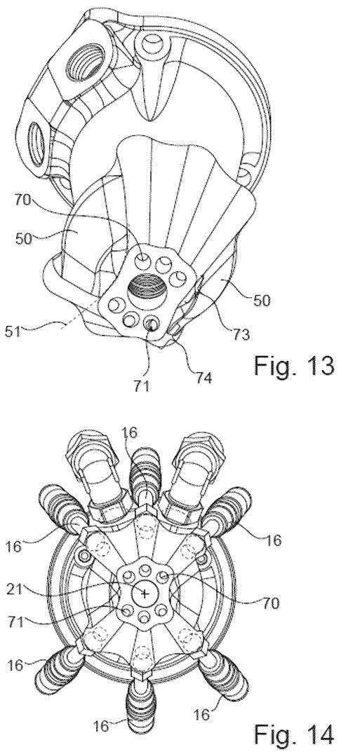

FIG. 13 shows another jet nozzle 1 with the chamfer 50 in a perspective view. The chamfer 50 can run in the distal region 8 in the manner of a passant 51 at an opening of the light channel 3. The passant 51 defines the orientation of the chamfer 50 on the mouth of the nozzle 6. In the end face of the jet nozzle 1 facing the workpiece, the passant 51 runs along a straight line or an arc that neither intersects nor touches the opening. In addition, there can be a further chamfer 50 on the end face of the jet nozzle 1 facing away from the workpiece. The two chamfers 50 can be arranged symmetrically to one another. The distance of the passant 51 from the center 20 of the light channel 3 is greater than the distance of the corresponding section of the elongated hole from the center 20 of the light channel 3. The distance between the passant 51 and an outer edge of the elongated hole is selected in such a way that the wall thickness therebetween ensures sufficient strength and resilience of the jet nozzle 1.

The orientation of the passant 51 and thus the orientation of the chamfer 50 at the mouth of the nozzle 6 can be varied for different jet nozzles 1 depending on the respective application. For example, the passant 51 can run in the direction of advance 2. Alternatively, the passant 51 can run transversely to the direction of advance 2, for example. Further alternatively, the passant 51 can, for example, run at an angle to the direction of advance 2 that lies between a course along the direction of advance 2 and transverse to the direction of advance 2. In this case, the passant 51 runs along the transition section between the long side of the elongated hole and the partial circular section of the elongated hole. The course of the passant 51 determines the orientation of the chamfer 50.

The powder unit 7 on the mouth of the nozzle 6 forms the powder section 11 in a circumferential direction around the light channel 3. This has a plurality of injector guides 19, into each of which a powder injector 16 can be inserted. A first injector guide 70 is located substantially opposite the first powder focus 21 above a second injector guide 71. In particular, the first injector guide 70 at the first powder focus 21 is point-mirrored to the second injector guide 71. In the embodiment example, there are four further injector guides, 2 of which are opposite each other. Accordingly, the jet nozzle in the present case has a total of six injector guides, of which the injector guides in a first powder section 73 each have an opposite counterpart in a second powder section 74. The opening of the light channel 3 can be a stretched opening in the form of an elongated hole or, as shown, a circular opening.

FIG. 14 shows the jet nozzle 1 from FIG. 13, wherein powder injectors 16 are inserted into the respective injector guides 19. The powder injectors run at an angle to the plane in which the end face of the jet nozzle 1 runs. Furthermore, each powder injector 16 has an opposite powder injector 16 mirrored at the first powder focus 21, and the first powder section 73 is separated from the second powder section 74 on both sides along the circumferential direction by a powder section gap.

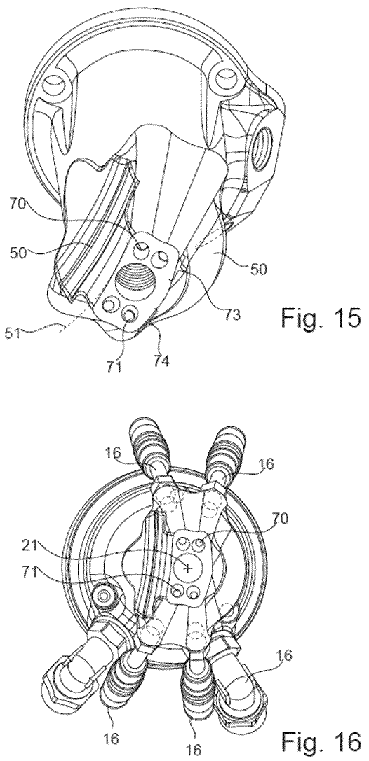

FIGS. 15 and 16 show a further embodiment of the jet nozzle 1. A first injector guide 70 is located opposite the second injector guide 71 in relation to the first powder focus 21. In the present case, the jet nozzle has a total of four injector guides 19. In FIG. 16, powder injectors 16 are inserted into the respective injector guides 19. The embodiment shown in FIGS. 15 and 16 is particularly suitable for creating precise functional layers with stepped component symmetries.

FIG. 17 shows the jet nozzle 1, which is aligned on a workpiece 100 with a hub cap 101. The drawing plane in FIG. 17 is the plane to which the direction of advance 2 is orthogonal. The jet nozzle 1 is inclined about an advance axis along which the direction of advance 2 runs. In FIG. 17, the jet nozzle 1 is moved towards a right flank of the hub cap 101 so that the jet nozzle 1 is inclined to the right about the advance axis. Due to the inclination of the jet nozzle 1 about the advance axis, a lateral incidence angle 45 is formed between the perpendicular 41 of the workpiece surface and the longitudinal axis 43 of the light channel. The lateral incidence angle 45 is independent of the posterior incidence angle 44, as described, for example, in connection with FIG. 11. The lateral incidence angle 45, particularly in conjunction with the chamfer 50, enables the jet nozzle 1 to be moved closer to the hub cap 101, whereby the functional layer can be applied to the workpiece 100 right up to the hub cap 101. If the workpiece 100 is a brake disk, this enables the entire friction surface of the brake disk to be provided with the functional layer up to the base of the hub cap 101. The lateral incidence angle 45 can be between 2° and 45°, in particular between 10° and 30°, in particular between 15° and 25°. One of the plurality of injector guides 19, in particular each of the plurality of injector guides 19, is inclined relative to the longitudinal axis 43 of the light channel in the plane shown, to which the direction of advance 2 extends orthogonally. In particular, the at least one injector guide 19, in particular the first injector guide 70 and/or the second injector guide 71 can be inclined by an injector angle 46 of between 10° and 25°.

The lateral incidence angle 45 indicates that there is at least one injector guide 75 inclined towards the workpiece 100. The injector guide 75 inclined towards the workpiece 100 can be any one of the plurality of injector guides 19. A workpiece angle 47, which extends between the direction of the injector guide 75 inclined towards the workpiece 100 and the workpiece surface, is determined by the sum of the lateral incidence angle 45 and the injector angle 46. It has been found that workpiece angles 47 that are too acute cause the applied functional layer to have waviness. In this respect, the lateral incidence angle 45 and the injector angle 46 are matched to each other in such a way that the workpiece angle 47 is a maximum of 30°, in particular a maximum of 45°, and in particular a maximum of 50°. At this workpiece angle 47, an optimum ratio between the quality of the functional layer and the proximity of the functional layer to the hub cup 101 is achieved. In this way, a smooth functional layer that is free of waviness can be efficiently realized with these incidence angles 45 and/or these injector angles 46. Thus, these incidence angles 45 and/or these injector angles 46 further contribute to avoiding imperfections in the functional layer when the injector guides 19 are arranged opposite one another. Furthermore, the chamfer 50 contributes to a flush approach of the jet nozzle 1 to the hub cup 101.

Insofar as applicable, all individual features presented in the exemplary embodiments can be combined with one another and/or interchanged, without departing from the scope of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

1 Jet nozzle
2 Direction of advance
3 Light channel
4 Lateral surface
5 Outer structure
6 Mouth of the nozzle
7 Powder unit
8 Distal region
9 Flange section
10 Proximal region
11 Powder section
12 Advance section
13 Coolant inlet
14 Coolant outlet
15 Coupling ring
16 Powder injector
17 Inlet connection
18 Outlet connection
19 Injector guide
20 Center of the light channel
21 First powder focus
22 First powder section
23 Second powder focus
24 Second powder section
25 Cooling system
31 Radially inner cooling chamber
32 Transition
33 Radially outer cooling chamber
34 Honeycomb structure
41 Perpendicular of the workpiece surface
42 End face
43 Longitudinal axis of the light channel
44 Posterior incidence angle
45 Lateral incidence angle
46 Injector angle
47 Workpiece angle
50 Chamfer
51 Passant
60 Process gas unit
61 Process gas section
62 Outlet opening
70 First injector guide
71 Second injector guide
72 Rear injector guide
73 First powder section
74 Second powder section
75 Injector guide inclined towards the workpiece
100 Workpiece
110 Laser beam
111 Primary beam
112 Secondary beam
120 Powdered filler material
130 Molten pool
140 Functional layer

1. A jet nozzle for laser cladding along a direction of advance, comprising:
a light channel for conducting at least one laser beam directed onto a workpiece; and
a powder unit arranged radially outside the light channel for conducting at least one jet of powder which is to be applied to the workpiece with at least a first powder focus,
wherein the powder unit forms a powder section at a mouth of the jet nozzle in a circumferential direction around the light channel, which powder section comprises a plurality of injector guides, into each of which a powder injector is configured to be inserted, wherein a first injector guide is located substantially opposite a second injector guide in relation to the first powder focus.

2. The jet nozzle according to claim 1, wherein the first injection guide and the second injector guide are point-mirrored at the first powder focus, so that two of the plurality of the injector guides are opposite each other relative to a center of the light channel.

3. The jet nozzle according to claim 1, wherein the plurality of the injector guides comprises an odd number of injector guides, wherein a rear injector guide, which is located at a rear in the direction of advance, is the only one of the plurality of the injector guides not to have an opposing injector guide, or wherein the plurality of the injector guides comprises an even number of injector guides, so that each injector guide has the opposing injector guide.

4. The jet nozzle according to claim 1, wherein, in a plane to which the direction of advance runs orthogonally, the first injector guide and/or the second injector guide is inclined relative to a longitudinal axis of the light channel by an injector angle of between 10° and 25°.

5. The jet nozzle according to claim 1, wherein each of the plurality of the injector guides is aligned with the first powder focus, wherein the first powder focus lies on a longitudinal axis of the light channel along which the at least one laser beam runs.

6. The jet nozzle according to claim 1, wherein a first part of the plurality of the injector guides is aligned with the first powder focus and a second part of the plurality of the injector guides is aligned with a second powder focus, wherein the first powder focus and the second powder focus extend along the direction of advance and form a focus line.

7. The jet nozzle according to claim 1, wherein a first powder injector is inserted into the first injector guide and is configured to convey a first powder mass flow and a second powder injector is inserted into the second injector guide and is configured to convey a second powder mass flow, wherein the first powder mass flow differs from the second powder mass flow and wherein the first powder mass flow conveys a powder which differs from the second powder mass flow.

8. The jet nozzle according to claim 1, wherein a cross-sectional area of the light channel extending orthogonally to a longitudinal direction of the jet nozzle is stretched in the direction of advance, deviating from a circular shape, and the powder section extends around the light channel along an elongated hole arc in the shape of a horseshoe.

9. The jet nozzle according to claim 1, wherein the powder section is composed of a first powder section and a second powder section, and the first powder section is separated from the second powder section by a powder section gap.

10. The jet nozzle according to claim 1, wherein the powder section extends in the circumferential direction around the light channel by a wrap angle of between 45° and 330°, or between 90° and 300°, or between 180° and 300°, relative to a center of the light channel.

11. The jet nozzle according to claim 1, wherein the light channel is configured to guide a plurality of laser beams comprising the at least one laser beam, wherein the plurality of laser beams comprises a first laser beam as a primary beam and a second laser beam as a secondary beam.

12. The jet nozzle according to claim 1, wherein a powder-unit-free advance section adjoins the powder section in the circumferential direction and is formed in a region of the mouth of the jet nozzle facing towards or away from the direction of advance, wherein a process gas unit for conducting a process gas is arranged radially outside the light channel, wherein the process gas unit forms a process gas section in the circumferential direction which occupies the advance section.

13. The jet nozzle according to claim 1, which is manufactured by means of an additive manufacturing process and comprises, copper, a copper alloy, or a copper-chromium-zirconium alloy.

14. The jet nozzle according to claim 1, wherein the mouth of the jet nozzle comprises a chamfer by which a part of the mouth of the jet nozzle is cut off, wherein the chamfer is substantially planar and extends in a plane which is inclined relative to the longitudinal direction of the jet nozzle.

15. A system comprising a jet nozzle according to claim 1 and a workpiece, wherein the jet nozzle is inclined about an advance axis, along which the direction of advance runs, to form a lateral incidence angle with respect to the workpiece, so that in a plane to which the direction of advance runs orthogonally, a longitudinal axis of the light channel, along which the at least one laser beam runs, deviates from a perpendicular of a workpiece surface of the workpiece.

16. The system according to claim 15, wherein the lateral incidence angle is between 2° and 45°, or between 5° and 30°, or between 10° and 25°.

17. The system according to claim 16, wherein at least one of the plurality of the injector guides is inclined relative to the longitudinal axis of the light channel in a plane to which the direction of advance extends orthogonally, wherein an angular sum of the lateral incidence angle and the injector angle is such that an injector guide inclined towards the workpiece encloses a workpiece angle of at most 30°, or at most 45°, or at most 500 with the workpiece.

18. A method for laser cladding along a direction of advance by means of a jet nozzle or a system according to claim 1, comprising the following steps:
aligning the jet nozzle with a workpiece; and
inclining the jet nozzle about an advance axis along which the direction of advance runs so that the jet nozzle forms a lateral incidence angle of less than 90° relative to the workpiece in a plane to which the direction of advance runs orthogonally.

19. The method according to claim 18, wherein the jet nozzle is inclined in such a way that an injector guide inclined towards the workpiece encloses a workpiece angle of at most 30°, or at most 45°, or at most 50° with the workpiece.

20. The system according to claim 16, wherein the at least one of the plurality of the injector guides is inclined relative to the longitudinal axis of the light channel in a plane to which the direction of advance extends orthogonally by an injector angle of between 10° and 25°.
